(19) United States
(12) Patent Application Publication
(10) Pub. No.: US 2012/0023748 A1
(43) Pub. Date: Feb. 2, 2012

(54) METHOD OF MAKING A SHAPED METAL PART FOR A MOTOR VEHICLE COMPONENT

(75) Inventors: MARTIN POHL, Altenbeken (DE); Otto Buschsieweke, Paderborn (DE); Stefan Adelbert, Delbruck (DE)

(73) Assignee: Benteler Automobiltechnik GmbH, Paderborn (DE)

(21) Appl. No.: 13/007,065

(22) Filed: Jan. 14, 2011

(30) Foreign Application Priority Data
Jan. 15, 2010 (DE) 102010004823.2-24

(51) Int. Cl. B21D 53/88; H05B 6/10; B21D 37/16

(52) U.S. Cl. 29/897.2; 72/342.6; 72/342.94; 219/646; 72/342.96

(57) ABSTRACT

In a method of making a shaped metal part for a motor vehicle component, a blank is made from a steel alloy containing, in weight percent: carbon (C) 0.18% to 0.3%, silicon (Si) 0.1% to 0.7%, manganese (Mn) 1.0% to 2.5%, phosphorus (P) maximal 0.025%, chromium (Cr) 0.1 to 0.8%, molybdenum (Mo) 0.1 to 0.5%, sulfur (S) maximal 0.01%, titanium (Ti) 0.02% to 0.05%, boron (B) 0.002% to 0.005%, aluminum (Al) 0.01% to 0.06%, balance iron and impurities resulting from smelting, The blank is heated to a temperature between 900° C. and 950° C., and formed in a press tool into a formed part which is quenched and tempered while still being in the press tool. At least one region of the formed part is then annealed to become soft by a heating operation within a time interval of less than 30 seconds to thereby provide the region with higher ductility.

### CROSS-REFERENCES TO RELATED APPLICATIONS

This application claims the priority of German Patent Application, Serial No. 10 2010 004 823.2-24, filed Jan. 15, 2010, pursuant to 35 U.S.C. 119(a)-(d), the content of which is incorporated herein by reference in its entirety as if fully set forth herein.

### BACKGROUND OF THE INVENTION

The present invention relates to a method of making a shaped metal part for a motor vehicle component, and in particular a shaped metal part having at least one region with higher ductility.

The following discussion of related art is provided to assist the reader in understanding the advantages of the invention, and is not to be construed as an admission that this related art is prior art to this invention.

The term “ductility” relates to the property of a material to enable a plastic deformation when exposed to excess load before failing. Ductile materials are increasingly in demand in the automobile industry. For example, the vehicle body of a motor vehicle should at least have some formed parts which are capable to undergo plastic deformation in the event of a collision so as to prevent them from being torn apart. Examples of such formed parts include i.a. door impact beams or bumpers.

To provide constant material properties throughout, the formed parts can be completely quenched and tempered, thereby attaining high strength values with tensile strengths of Rₘ of about 1,500 N/mm². This, however, lowers ductility of the material, so that the material loses its capacity to deform in a permanent manner. The breaking elongation A₅ is typically about 10%.

Press formed parts that have been quenched and tempered in a tool can be provided with varying plastic stiffness behavior by differentially rolling starting blanks before shaping. In this way, wall thicknesses of the press formed parts can be reduced in some areas. Although a decrease in the wall thickness in some areas through rolling results in varying stiffness behavior, manufacturing costs and investment costs increase and the applicability of the rolling operation depends on the configuration of the respective region to be rolled and thus can quickly reach its limits. This is true especially when rolling of narrow regions of the formed parts is involved.

Formed parts can be provided with regions of higher ductility by integrating face plates for example in the form of inserts of softer steel quality, in the formed part. This complicates manufacture and increases costs. In addition, the empty weight is significantly increased.

It would therefore be desirable and advantageous to provide an improved method of making a shaped metal part having at least one region of higher ductility to obviate prior art shortcomings and to enable a simpler, more efficient and thus economical manufacture thereof for a wide range of variations with respect to geometrical configurations.

### SUMMARY OF THE INVENTION

According to one aspect of the present invention, a method of making a shaped metal part for a motor vehicle component includes the steps of making a blank from a steel alloy containing, in weight percent, carbon (C) 0.18% to 0.3%, silicon (Si) 0.1% to 0.7%, manganese (Mn) 1.0% to 2.5%, phosphorus (P) maximal 0.025%, chromium (Cr) 0.1 to 0.8%, molybdenum (Mo) 0.1 to 0.5%, sulfur (S) maximal 0.01%, titanium (Ti) 0.02% to 0.05%, boron (B) 0.002% to 0.005%, aluminum (Al) 0.01% to 0.06%, balance iron and impurities resulting from smelting, heating the blank to a temperature between 900° C. and 950° C., forming the blank in a press tool into a formed part, quenching and tempering the formed part in the press tool, and annealing at least one region of the formed part to become soft by a heating operation within a time interval of less than 30 seconds to thereby provide the region with a ductility which is higher than a ductility of the remainder of the formed part.

The present invention resolves prior art problems by having the formed part to undergo an annealing process to make is soft in a targeted region within a particular time period below the hypoeutectoid region in the iron carbon diagram. As a result, defects such as dislocations or offsets can be remedied and material stress in the formed part can be decreased. Thereafter, recrystallization occurs to form new cores and to replace greatly prestressed crystallites. Finally, crystal growth takes place. The particular state of the microstructure before annealing is secondary. Important is only the change in breaking elongation and hardness. As a result of the annealing temperature, the strip-shaped cementite loses strength and is able to follow its tendency to attain a body with smallest possible surface. A grainy cementite forms so that the material is easily malleable and can also be machined.

The heating operation during soft-annealing may be realized in various ways. For example, the heating operation may be carried out inductively or conductively. Other examples include heating by irradiation or using open burners. Of course, combinations thereof may also be conceivable.

According to another advantageous feature of the present invention, the formed part may be transferred after the annealing step to a clamping device, and cooled while the formed part is held in the clamping device. In this way, geometric distortions of the formed part during the cooling phase after annealing can be avoided. For example, a forming tool may be used as clamping device.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic perspective view of one embodiment of a pot-shaped formed part with a transversely extending ductile region;

FIG. 2 is a schematic perspective view of another embodiment of a pot-shaped formed part with a strip-shaped ductile region in a topside of the formed part;

FIG. 3 is a schematic perspective view of yet another embodiment of a pot-shaped formed part with strip-shaped ductile regions in flanges of the formed part; and

FIG. 4 is a schematic illustration of a manufacturing sequence for making a formed part of FIGS. 1 to 3 in accordance with the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

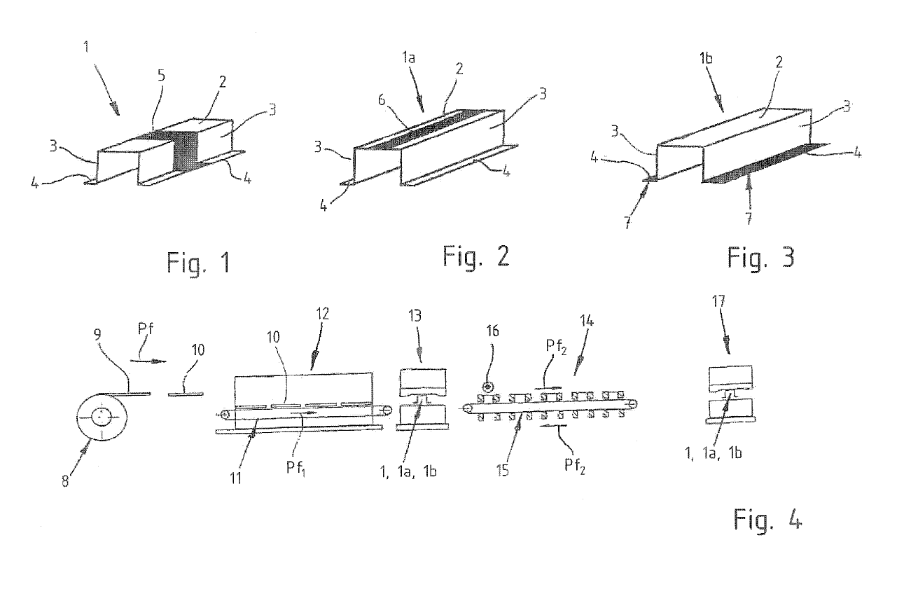

Turning now to the drawing, and in particular to FIG. 1, there is shown a schematic perspective view of a pot-shaped formed part, generally designated by reference numeral 1 for the production of a motor vehicle component which is not shown in greater detail for the sake of simplicity and may constitute, for example, a door impact beam or bumper. The formed part 1 includes a topside 2, two sidewalls 3 respectively joined to opposite ends of the topside 2, and two flanges 4 respectively extending transversely from the ends of the sidewalls 3.

As shown in FIG. 1, the formed part 1 is provided approximately in a central length section with a strip-shaped region 5 which extends in longitudinal direction of the topside 2 transversely across the topside 2, the sidewalls 3, and the flanges 4. Compared to the rest of the formed part 1 which is less capable to deform and less stiff, in the region 5, the material of the formed part 1 has low strength but high ductility.

FIG. 2 is a schematic perspective view of another embodiment of a pot-shaped formed part, generally designated by reference numeral 1a. Parts corresponding with those in FIG. 1 are denoted by identical reference numerals and not explained again. The description below will center on the differences between the embodiments. In this embodiment, the formed part 1a has a strip-shaped region 6 of low strength and high ductility which extends in midsection in longitudinal direction of the topside 2.

FIG. 3 is a schematic perspective view of yet another embodiment of a pot-shaped formed part, generally designated by reference numeral 1b. Parts corresponding with those in FIG. 1 are again denoted by identical reference numerals and not explained. The description below will center on the differences between the embodiments. In this embodiment, the formed part 1a has regions 7 of high ductility which extend along the flanges 4 of the formed part 1b. In the non-limiting example of FIG. 3, the flanges 7 are configured in their entirety 6 as regions 7 of high ductility.

Referring now to FIG. 4, there is shown a schematic illustration of a manufacturing sequence for making a formed part 1, 1a, 1b according to FIGS. 1 to 3. A strip-shaped starting material 9 is wound on a coil 8 and made from a steel alloy including in weight percent:

| | |
|---|---|
| Carbon (C) | 0.18% to 0.3% |
| Silicon (Si) | 0.1% to 0.7% |
| Manganese (Mn) | 1.0% to 2.5% |
| Phosphorus (P) | maximal 0.025% |
| Chromium (Cr) | 0.1 to 0.8% |
| Molybdenum (Mo) | 0.1 to 0.5% |
| Sulfur (S) | maximal 0.01% |
| Titanium (Ti) | 0.02% to 0.05% |
| Boron (B) | 0.002% to 0.005% |
| Aluminum (Al) | 0.01% to 0.06%, and |

balance iron and impurities resulting from smelting.

The starting material 9 is drawn from the coil 8 in a direction of arrow Pf and cut to size into blanks 10 in a device not shown in greater detail. The blanks 10 are then placed on a transport device 11 for passage through a furnace 12 in a direction of arrow Pf₁. In the furnace 12, the blanks 10 are heated homogenously to a temperature between 900° C. and 950° C. Any type of heating is applicable here. Following the homogenous heating process, each blank 10 is shaped in a press tool 13 to a formed part 1, 1a, 1b having a pot-shaped cross section. While being in the press tool 13, the formed part 1, 1a, 1b is also quenched and tempered in a manner not shown in greater detail.

After undergoing the shaping and quenching and tempering steps in the press tool 13, the formed part 1, 1a, 1b is differentially soft-annealed to provide a region of low strength and high ductility, as shown and described with reference to FIGS. 1 to 3, i.e. the transverse region 5 in midsection of formed part 1, the strip-shaped region 6 in longitudinal direction of the topside 2 of formed part 1a, and in formed part 1b the flanges 4 configured in their entirety with strip-shaped regions 7 of low strength and high ductility.

This differential annealing to soften the formed parts 1, 1a, 1b in the regions 5, 6, 7, respectively, is suitably carried out below the hypoeutectoid region in the iron carbon diagram, with the heating operation during soft-annealing implemented within a time period of less than 30 seconds. The heating operation may be realized in a heating facility 14 in which the formed part 1, 1a, 1b is temporarily restrained on a conveyor 15 which moves in a direction of arrows Pf₂. The heating operation may be executed inductively, conductively, by irradiation, or with open burners. The actual heating device is designated in FIG. 4 by reference numeral 16. Of course, the heating device 16 may be located at any suitable position in the heating facility 14.

Following the heating operation for soft-annealing is a cooling step during which the formed part 1, 1a, 1b is held in a clamping device 17 which, for example, may be a forming tool configured as the press tool 13.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of making a shaped metal part for a motor vehicle component, comprising the steps of:
making a blank from a steel alloy containing, in weight percent:

| | |
|---|---|
| Carbon (C) | 0.1 8% to 0.3% |
| Silicon (Si) | 0.1% to 0.7% |
| Manganese (Mn) | 1.0% to 2.5% |
| Phosphorus (P) | maximal 0.025% |
| Chromium (Cr) | 0.1 to 0.8% |
| Molybdenum (Mo) | 0.1 to 0.5% |
| Sulfur (S) | maximal 0.01% |
| Titanium (Ti) | 0.02% to 0.05% |
| Boron (B) | 0.002% to 0.005% |
| Aluminum (Al) | 0.01% to 0.06%, |

balance iron and impurities resulting from smelting;
heating the blank to a temperature between 900° C. and 950° C.;
forming the blank in a press tool into a formed part;
quenching and tempering the formed part in the press tool; and
annealing at least one region of the formed part to become soft by a heating operation within a time interval of less than 30 seconds to thereby provide the region with a ductility which is higher than a ductility of the remainder of the formed part.

2. The method of claim 1, wherein the heating operation during the annealing step is carried out inductively.

3. The method of claim 1, wherein the heating operation during the annealing step is carried out conductively.

4. The method of claim 1, wherein the heating operation during the annealing step is carried out by irradiation.

5. The method of claim 1, wherein the heating operation during the annealing step is carried out using open burners.

6. The method of claim 1, further comprising transferring the formed part after the annealing step to a clamping device, and cooling the formed part while the formed part is held in the clamping device.

7. The method of claim 6, wherein the clamping device is a forming tool.
